(19) United States
(12) Patent Application Publication
(10) Pub. No.: US 2026/0147994 A1
(43) Pub. Date: May 28, 2026

(54) LOW-LEVEL, MULTI-AGENT COMMUNICATIONS

(71) Applicant: Cisco Technology, Inc., San Jose, CA (US)

(72) Inventors: Advit Deepak, San Jose, CA (US); Jayanth Srinivasa, Newark, CA (US); Charles Fleming, Oxford, MS (US); Ramana Rao V.R. Kompella, Foster City, CA (US); Myungjin Lee, Bellevue, WA (US)

(73) Assignee: Cisco Technology, Inc., San Jose, CA (US)

(21) Appl. No.: 18/958,572

(22) Filed: Nov. 25, 2024

(51) Int. Cl. G06F 40/20; G10L 15/16

(52) U.S. Cl. CPC G06F 40/20; G10L 15/16

(57) ABSTRACT

In one implementation, a device receives a natural language input for processing by a first agent executed by the device. The first agent generates, based on the natural language input, an output in a first embedding space using an artificial intelligence model. The first agent identifies a second agent for further processing of the output. The first agent provides the first agent, the output for further processing by a second agent.

### TECHNICAL FIELD

The present disclosure relates generally to artificial intelligence (AI)-based agents and, more particularly, to low-level, multi-agent communications.

### BACKGROUND

The recent breakthroughs in large language models (LLMs), such as GPT-4, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

In more complex implementations, multiple agents may interact with one another as part of an agentic system. Indeed, different agents may have different specializations and capabilities. Thus, chaining their processing together could lead to increased performance. However, in systems employing multiple agents, interactions between the agents typically entail the agents engaging in chat sessions with one another, similar to how they would interact with a user. Such communications are insecure and vulnerable to exploitation. For instance, with English-based agents, anyone who can read English could eavesdrop on the information that the agents exchange, meaning that anyone who can write English can perform injection attacks to manipulate the system maliciously.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of a user interfacing with a language model;

FIG. 4 illustrates an example architecture for an artificial intelligence (AI) agent;

FIG. 5 illustrates an example of an AI agent interfacing with another AI agent;

FIG. 6 illustrates an example of low-level, multi-agent communications between AI agents; and

FIG. 7 illustrates an example of a simplified procedure for low-level, multi-agent communications, in accordance with one or more implementations described herein.

### DESCRIPTION OF EXAMPLE IMPLEMENTATIONS

### Overview

According to one or more implementations of the disclosure, a device receives a natural language input for processing by a first agent executed by the device. The first agent generates, based on the natural language input, an output in a first embedding space using an artificial intelligence model. The first agent identifies a second agent for further processing of the output. The first agent provides the first agent, the output for further processing by a second agent.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

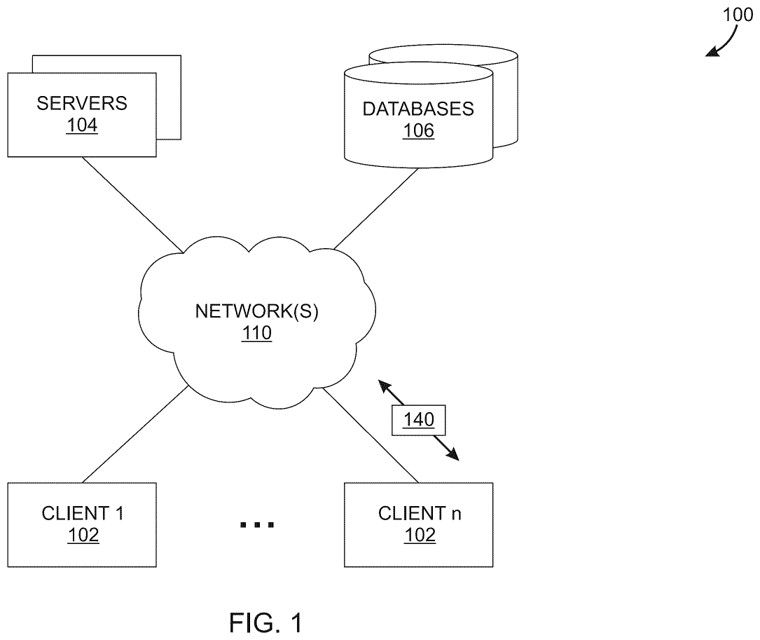

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

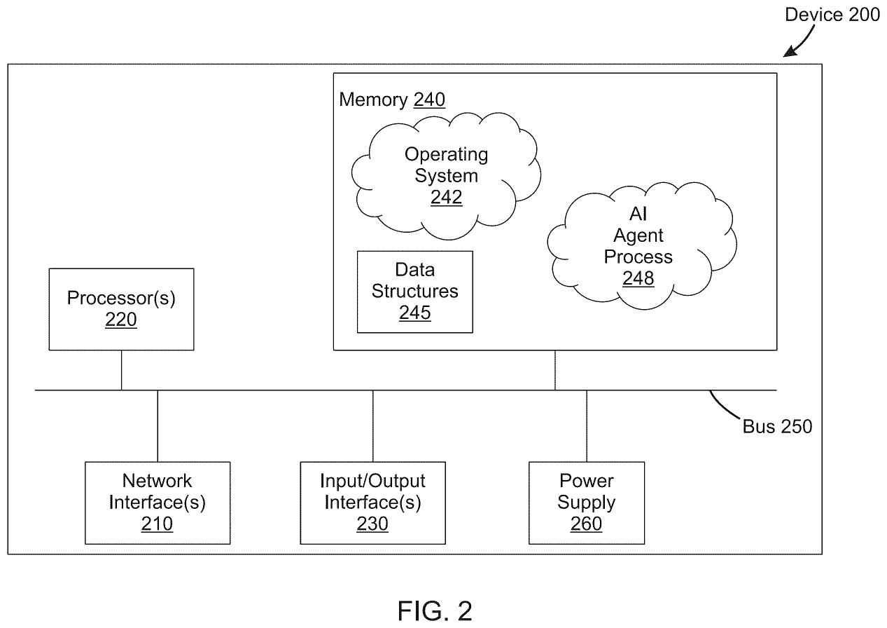

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise AI agent process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, AI agent process 248 may include computer executable instructions that, when executed by processor 220, cause device 200 to perform the techniques described herein. To do so, in some implementations, AI agent process 248 may utilize AI/machine learning. In general, AI/machine learning is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, AI agent process 248 may employ and/or be utilized to handle prompts to and/or access of one or more supervised, unsupervised, or semi-supervised AI/machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/machine learning techniques that the AI agent process 248 can employ and/or be utilized in concert with may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI agent process 248 may also include, or otherwise use or be employed to operate with, one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, AI agent process 248 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs) and other foundation models, diffusion models, transformer models, and the like.

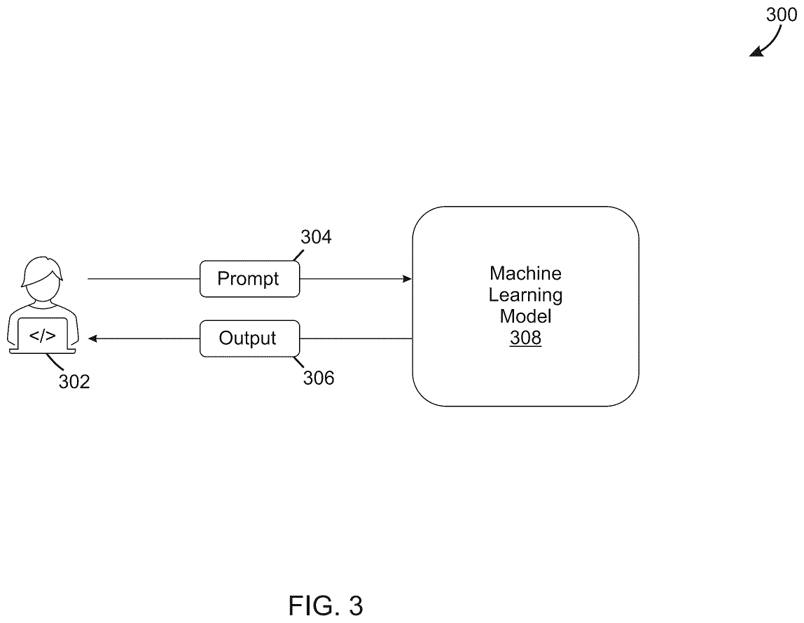

FIG. 3 illustrates an example 300 for interfacing with a language model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be a model configured to apply its trained algorithms to generate a response (e.g., output 306) based on the prompt 304 provided. For instance, in some cases, generative model 308 may take the form of a large language model (LLM) or other foundation model, diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated and/or synthesized image, a text response, a classification and/or prediction, etc.

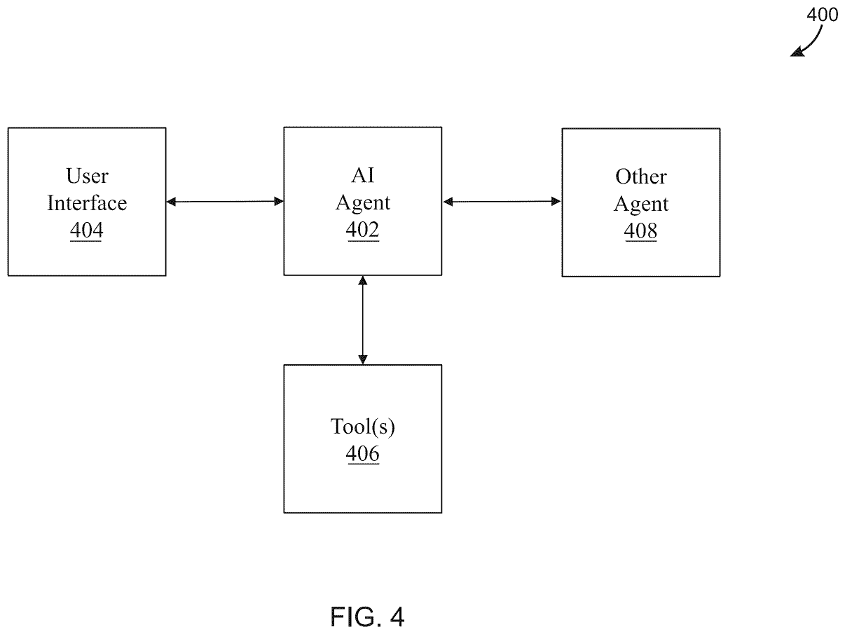

As noted above, AI agents are also capable of interacting with generative models, such as generative model 308, which may be integrated directly into the agent or accessed via an API. FIG. 4 illustrates an example architecture 400 for an artificial intelligence (AI) agent, according to various implementations. At the core of architecture 400 is AI agent 402, which may be implemented through execution of AI agent process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

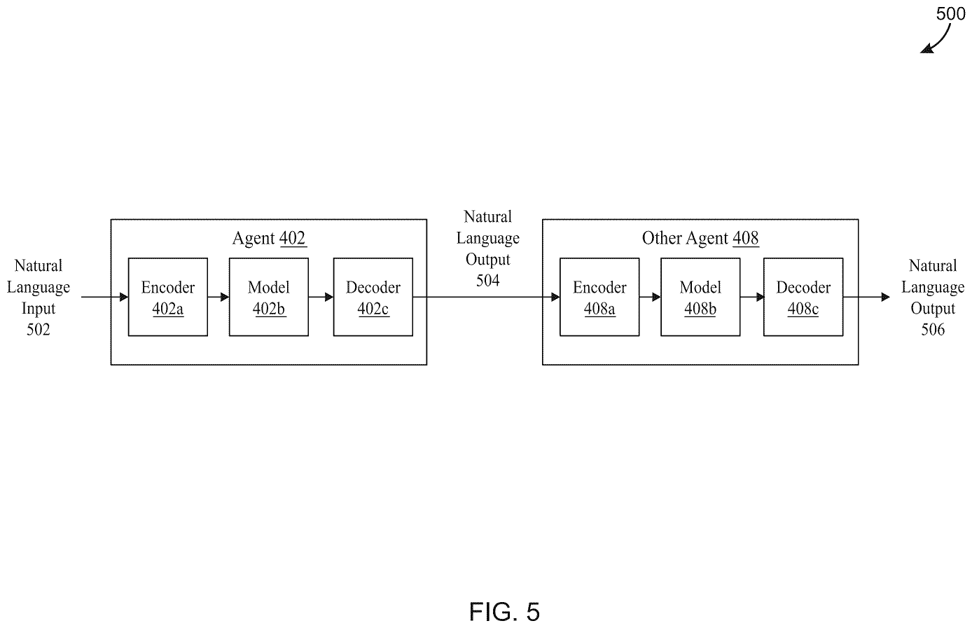

FIG. 5 illustrates an example 500 of an AI agent interfacing with another AI agent, in some implementations. Continuing the example of FIG. 4, consider the case in which a user issues a natural language input 502 to AI agent 402. Generally, natural language refers to any human-made language that developed naturally in use (e.g., English, Chinese, Italian, etc.), as opposed to machine languages. In some implementations, AI agent 402 may include the following components: an encoder 402a configured to convert natural language input 502 into an embedding space, a model 402b configured to take as input the embedding representation of natural language input 502 as input and generate an output in that embedding space, and a decoder 402c that converts the embedding version of the output of model 402b back into natural language as natural language output 504.

As would be appreciated, an embedding space is a space that represents tokens (e.g., natural language words, etc.) as vectors. Doing so allows for the representation of concepts in a mathematic fashion. For instance, the distance between words/vectors in the embedding space may represent how close those words are from a conceptual standpoint. Large language models (LLM) typically operate in such spaces to iteratively predict the next token in a sequence, given the input prompt.

Once AI agent 402 has generated natural language output 504, it may provide natural language output 504 to other agent 408 for further processing. For instance, continuing the previous example of the user asking about poor performance during a videoconference, natural language output 504 may take the form of an English-based query, “are there any network conditions for user X that could affect their videoconference?” In turn, other agent 408 may leverage its own components, such as encoder 408a, model 408b, and 408c, which operate in a similar manner to that of the components of AI agent 402, to generate natural language output 506, which it may return directly to natural language input 502 or back to AI agent 402.

One observation herein is that a malicious actor could potentially intercept natural language output 504 between AI agent 402 and other agent 408. Indeed, by using natural language for the communications between AI agent 402 and other agent 408, this presents opportunities for a man-in-the-middle attack whereby the malicious actor passes a malicious input to other agent 408 instead of natural language output 504, thereby tricking it into believing that the malicious input is from AI agent 402.

### Low-Level, Multi-Agent Communications

The techniques herein introduce an approach to securing communications between AI-based agents. In some implementations, the techniques herein do so by using embeddings to share information between agents, rather than readable text that could be intercepted.

Illustratively, the techniques described herein may be performed by hardware, software, and/or firmware, such as in accordance with AI agent process 248, which may include computer executable instructions executed by the processor 220 (or independent processor of interfaces 210) to perform functions relating to the techniques described herein.

Specifically, according to various implementations, a device receives a natural language input for processing by a first agent executed by the device. The first agent generates, based on the natural language input, an output in a first embedding space using an artificial intelligence model. The first agent identifies a second agent for further processing of the output. The first agent provides the first agent, the output for further processing by a second agent.

Operationally, to secure the communications between AI agents, the techniques herein introduce a non-lingual communication approach for inter-agent communications. In various implementations, the underlying model (e.g., LLM) of each agent may rely on a unique word/token embedding algorithm, meaning that each agent in the agentic system may have. The agentic system may maintain information regarding each of these embedding spaces for each agent in the system.

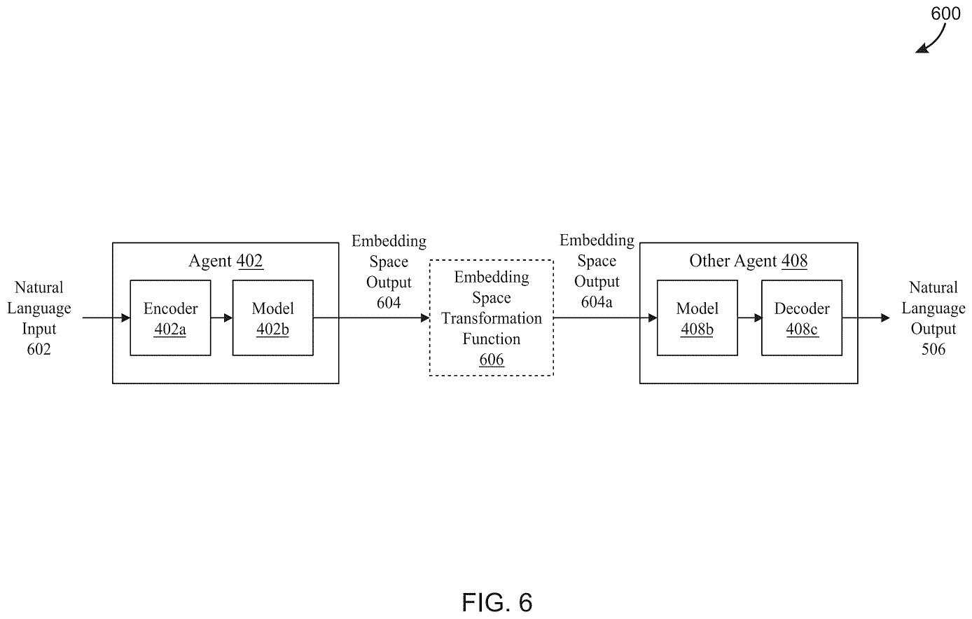

FIG. 6 illustrates an example 600 of low-level, multi-agent communications between AI agents, according to various implementations. Continuing the previous examples, rather than AI agent 402 communicating with other agent 408 using natural language, the techniques herein propose that it instead communicate a message based in an embedding space. Doing so helps to prevent man-in-the-middle attacks, as it would also require the malicious entity to have knowledge of the specific decoding algorithm for that embedding space.

As shown, in response to AI agent 402 receiving a natural language input 602, it may use encoder 402a to convert it into an embedding space for input to model 402b. However, rather than AI agent 402 then using decoder 402c to convert the output of model 402b back into natural language from its embedding space, AI agent 402 may instead provide the embedding space output 604 within its communication to other agent 408. Since this communication is already in an embedding space, other agent 408 no longer needs to use its encoder 408a to convert the incoming communication from natural language into an embedding.

According to various implementations, two possibilities exist: 1.) both AI agent 402 and other agent 408 use the same embedding space or 2.) AI agent 402 and other agent 408 use different embedding spaces. In the former case, embedding space output 604 could be sent directly to other agent 408 and input to its model 408b. However, the latter case presents even more security to the agentic system as compromise of the entire system would require n-number of embedding spaces, where n is the number of agents in the system.

In cases in which AI agent 402 and other agent 408 use different embedding algorithms and spaces, the system may also make use of an embedding space transformation function 606 that is configured to map embeddings in the embedding space of AI agent 402 to that of other agent 408 (and vice-versa, as desired). Thus, when AI agent 402 generates embedding space output 604 in the first embedding space associated with AI agent 402, AI agent 402 may then pass embedding space output 604 through embedding space transformation function 606 to generate embedding space output 604a, which is instead in the embedding space of other agent 408.

Various possibilities exist with respect to the execution of embedding space transformation function 606. In some cases, AI agent 402 may leverage embedding space transformation function 606 locally, prior to sending embedding space output 604a onwards towards other agent 408 for further processing. In another case, other agent 408 may instead leverage embedding space transformation function 606 to convert embedding space output 604 sent by AI agent 402 into embedding space output 604a for input to model 408b. In yet another implementation, embedding space transformation function 606 could be executed by an intermediary between the devices of AI agent 402 and other agent 408.

Regardless of whether embedding space transformation function 606 is used, privacy is greatly strengthened and redundant calculations are removed. For debugging purposes, the system could still include a secure decoding mechanism to decode embedding space output 604 and/or embedding space output 604a for review by an expert user. This framework also helps to prevent man-in-the-middle attacks, as a malicious actor needs access to the embedding space of AI agent 402, the embedding space of other agent 408, and embedding space transformation function 606, as well. As a result, malicious actors cannot monitor communication, inject malicious input within a chain of agent interactions, or poison group chat environments.

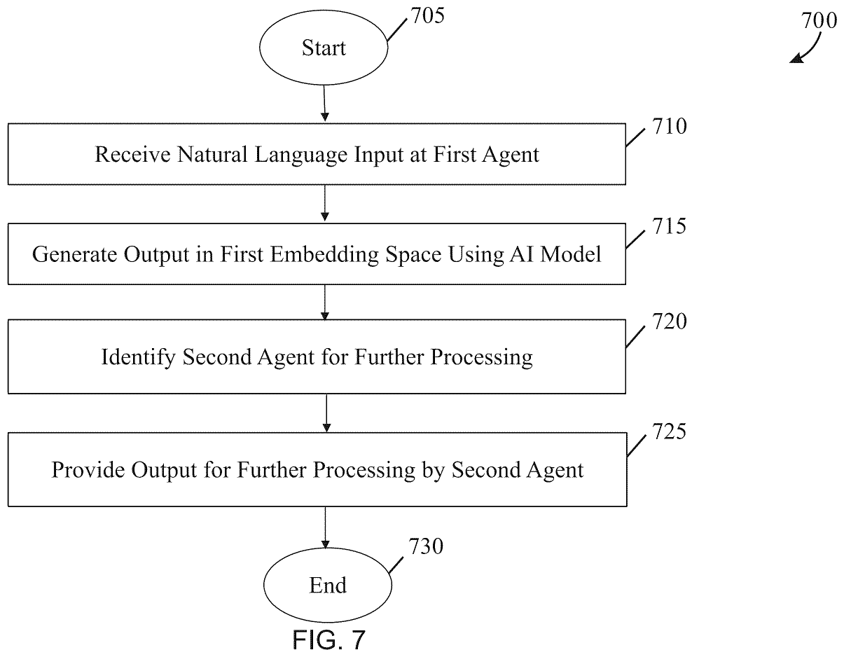

FIG. 7 illustrates an example of a simplified procedure for synthetic network traffic data generation, in accordance with one or more implementations described herein. For example, a non-generic, specifically configured device (e.g., device 200), may perform procedure 700 (e.g., a method) by executing stored instructions (e.g., AI agent process 248). The procedure 700 may start at step 705, and continues to step 710, where, as described in greater detail above, the device (e.g., a controller, server, etc.) may receive, a natural language input for processing by a first agent executed by the device. In some implementations, the device receives the natural language input via a user interface.

At step 715, as detailed above, the device may generate, by the first agent and based on the natural language input, an output in a first embedding space using an artificial intelligence model. In some implementations, the device may do so in part by converting the natural language input into the first embedding space for input to the artificial intelligence model. In one implementation, the artificial intelligence model is a large language model (LLM). In a further implementation, the first agent generates the output further using one or more tool interfaces.

At step 720, the device may identify, by the first agent, a second agent for further processing of the output, as described in greater detail above. In various implementations, the first agent may do so based on the input, the output from its model, any know capabilities of the second agent, combinations thereof, or the like.

At step 725, as detailed above, the device may provide, by the first agent, the output for further processing by a second agent. In various implementations, the first agent may cause the output to be transformed from being in the first embedding space to being in a second embedding space used by the second agent. In one implementation, this may entail inputting the output to a transformation function executed by the device. In another implementation, this may entail sending the output to a second device. In some instances, the second agent provides a result of its further processing of the output back to the first agent. In one implementation, the second agent returns a result of its further processing of the output back to a user interface.

Procedure 700 may then end at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for text-to-traffic synthetic network traffic generation system, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
receiving, at a device, a natural language input for processing by a first agent executed by the device;
generating, by the first agent and based on the natural language input, an output in a first embedding space using an artificial intelligence model;
identifying, by the first agent, a second agent for further processing of the output; and
providing, by the first agent, the output for further processing by a second agent.

2. The method as in claim 1, wherein generating the output comprises:
converting, by the device, the natural language input into the first embedding space for input to the artificial intelligence model.

3. The method as in claim 1, wherein the artificial intelligence model is a large language model (LLM).

4. The method as in claim 1, wherein the device receives the natural language input via a user interface.

5. The method as in claim 1, wherein providing the output for further processing by a second agent comprises:
causing, by the first agent, the output to be transformed from being in the first embedding space to being in a second embedding space used by the second agent.

6. The method as in claim 5, wherein causing the output to be transformed from being in the first embedding space to being in the second embedding space comprises:
inputting the output to a transformation function executed by the device.

7. The method as in claim 5, wherein causing the output to be transformed from being in the first embedding space to being in the second embedding space comprises:
sending the output to a second device.

8. The method as in claim 1, wherein the second agent provides a result of its further processing of the output back to the first agent.

9. The method as in claim 1, wherein the first agent generates the output further using one or more tool interfaces.

10. The method as in claim 1, wherein the second agent returns a result of its further processing of the output back to a user interface.

11. An apparatus, comprising:
one or more network interfaces;
a processor coupled to the one or more network interfaces and configured to execute one or more processes; and
a memory configured to store a process that is executable by the processor, the process when executed configured to:
receive, a natural language input for processing by a first agent executed by the apparatus;
generate, by the first agent and based on the natural language input, an output in a first embedding space using an artificial intelligence model;
identify, by the first agent, a second agent for further processing of the output; and
provide, by the first agent, the output for further processing by a second agent.

12. The apparatus as in claim 11, wherein the apparatus generates the output by:
converting the natural language input into the first embedding space for input to the artificial intelligence model.

13. The apparatus as in claim 11, wherein the artificial intelligence model is a large language model (LLM).

14. The apparatus as in claim 11, wherein the apparatus receives the natural language input via a user interface.

15. The apparatus as in claim 11, wherein the apparatus provides the output for further processing by a second agent by:
causing, by the first agent, the output to be transformed from being in the first embedding space to being in a second embedding space used by the second agent.

16. The apparatus as in claim 15, wherein the apparatus causes the output to be transformed from being in the first embedding space to being in the second embedding space by:
inputting the output to a transformation function executed by the apparatus.

17. The apparatus as in claim 15, wherein the apparatus causes the output to be transformed from being in the first embedding space to being in the second embedding space by:
sending the output to a second device.

18. The apparatus as in claim 11, wherein the second agent provides a result of its further processing of the output back to the first agent.

19. The apparatus as in claim 11, wherein the first agent generates the output further using one or more tool interfaces.

20. A tangible, non-transitory, computer-readable medium storing program instructions that cause a device to execute a process comprising:
receiving, at the device, a natural language input for processing by a first agent executed by the device;
generating, by the first agent and based on the natural language input, an output in a first embedding space using an artificial intelligence model;
identifying, by the first agent, a second agent for further processing of the output; and
providing, by the first agent, the output for further processing by a second agent.
